(19) United States
(12) Patent Application Publication
(10) Pub. No.: US 2026/0126025 A1
(43) Pub. Date: May 7, 2026

(54) DUAL FUEL INJECTOR FOR INJECTION CONTROL AND FUEL METERING, AND METHOD FOR OPERATING SAME

(71) Applicant: Caterpillar Inc., Peoria, IL (US)

(72) Inventor: Bryan Edward Nelson, Chillicothe, IL (US)

(73) Assignee: Caterpillar Inc., Peoria, IL (US)

(21) Appl. No.: 18/935,735

(22) Filed: Nov. 4, 2024

(51) Int. Cl. F02M 43/04; F02M 59/36; F02M 59/46

(52) U.S. Cl. CPC F02M 43/04; F02M 59/366; F02M 59/46

(57) ABSTRACT

A fuel injector in a dual fuel system forms a first nozzle supply passage for a first fuel, a multi-channel nozzle supply path for a second fuel, and a combined-fuel outlet passage. The fuel injector further forms a valve seat and a check control chamber, and includes a control valve movable between a first position and an open position, to control a hydraulic pressure of the second fuel in the check control chamber. The fuel injector further includes a nozzle check movable from a closed position blocking the plurality of nozzle outlets from the combined-fuel outlet passage, to an open position to inject a combined fuel charge containing both the first fuel and the second fuel. The multi-channel nozzle supply passage provides flow area especially for operating the dual fuel system in a diesel-only mode. e

### TECHNICAL FIELD

The present disclosure relates generally to a dual fuel system, and more particularly to metering a fuel in a fuel injector having a multifunctional control valve and a multi-channel nozzle supply path.

### BACKGROUND

Dual fuel engine systems have been known for decades. While traditional engine systems typically utilize a single fuel type such as diesel, gasoline, or natural gas, in a dual fuel engine system two different fuels each having different desirable properties are typically combusted together in an engine cylinder.

In one known strategy, a relatively small pilot charge of a compression-ignition fuel such as diesel is used to ignite a relatively larger main charge of a gaseous fuel such as natural gas. The diesel fuel is relatively easily ignited by way of an increased temperature and pressure in a cylinder, with the ignition of the diesel fuel triggering ignition of the gaseous fuel.

More recently, engineers have proposed dual liquid fuel strategies employing a leading fuel and a trailing fuel, both in a liquid form and injected as a single fuel charge. U.S. Pat. No. 11,384,721 B1 proposes a strategy that may operate by injecting a leading diesel fuel followed by a trailing alcohol fuel from the same passage into an engine cylinder for combustion. While the '721 patent undoubtedly has practical applications, there is always room for improvement and development of alternative strategies.

### SUMMARY

In one aspect, a dual fuel system includes a first fuel supply for a first fuel, a second fuel supply for a second fuel, and a fuel injector. The fuel injector forms a first fuel inlet fluidly connecting a first nozzle supply passage to the first fuel supply, a second fuel inlet fluidly connecting a multi-channel nozzle supply path to the second fuel supply, and a combined-fuel outlet passage fluidly connected to both the first nozzle supply passage and to the multi-channel nozzle supply path, and extending to a plurality of nozzle outlets. The fuel injector further forms a valve seat, and includes a control valve movable between a first position in contact with the valve seat and blocking the multi-channel nozzle supply path from the second fuel inlet, and an open position. The fuel injector further includes a nozzle check movable from a closed position blocking the plurality of nozzle outlets from the combined-fuel outlet passage, to an open position to inject a combined fuel charge containing both the first fuel and the second fuel.

In another aspect, a fuel injector includes an injector housing forming a first nozzle supply passage for a first fuel, a multi-channel nozzle supply path for a second fuel, a combined-fuel outlet passage fluidly connected to both the first nozzle supply passage and the multi-channel nozzle supply path and extending to a plurality of nozzle outlets. The injector housing further forms a valve seat, a check control chamber, and a fuel inlet for the second fuel. The fuel injector also includes a control valve movable between a first position and an open position, to control a hydraulic pressure of the second fuel in the check control chamber, and to selectively fluidly connect the multi-channel nozzle supply passage to the second fuel inlet. The injector further includes a nozzle check movable from a closed position blocking the plurality of nozzle outlets from the combined-fuel outlet passage, to an open position, to inject a combined fuel charge containing both the first fuel and the second fuel.

In yet another aspect, a method of operating an engine system includes feeding a first fuel into a first nozzle supply passage in a fuel injector and feeding a second fuel into a multi-channel nozzle supply path in the fuel injector. The method also includes opening a control valve at a first timing to admit the second fuel into the multi-channel nozzle supply path, closing the control valve, and opening the control valve at a second timing to reduce a closing hydraulic pressure on a nozzle check in the fuel injector. The method further includes opening the nozzle check based on the reduction to the closing hydraulic pressure to inject a fuel charge into a cylinder in an engine.

### BRIEF DESCRIPTION OF DRAWINGS

FIG. 1 is a diagrammatic view of a dual fuel engine system, according to one embodiment;

FIG. 2 is a sectioned side diagrammatic view of a fuel injector suitable for use in the engine system of FIG. 1; and

FIG. 3 is a sectioned side diagrammatic view through a portion of the fuel injector as in FIG. 2.

### DETAILED DESCRIPTION

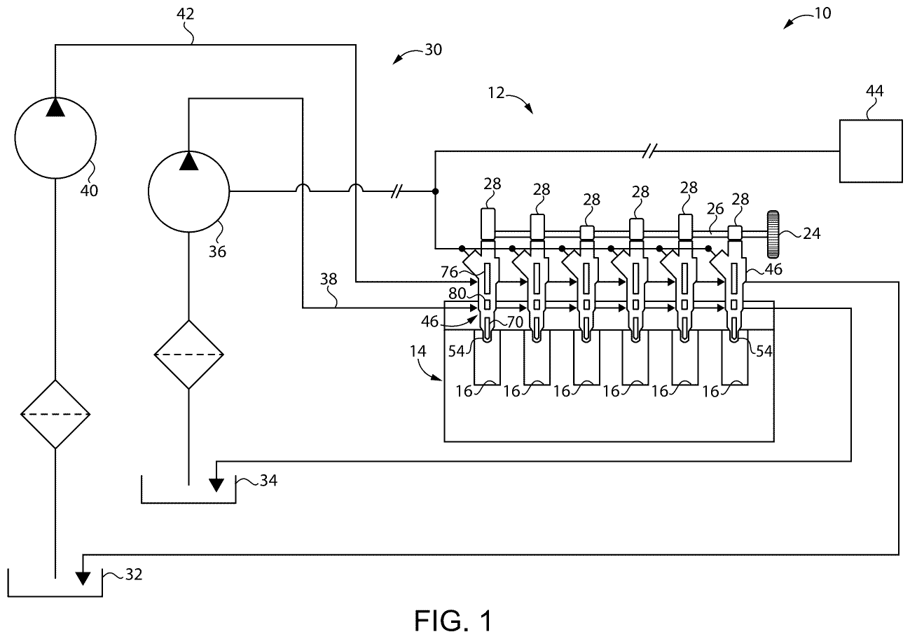

Referring to FIG. 1, there is shown a dual fuel internal combustion engine system 10 (hereafter “engine system 10”), according to one embodiment. Engine system 10 includes a dual fuel engine 12 (hereafter “engine 12”) having an engine housing 14 with a plurality of combustion cylinders 16 formed therein. Engine housing 14 will typically include a cylinder block forming cylinders 16, and an engine head arranged in one or more engine head sections. It should be noted that engine system 10 can include any number of cylinders in any suitable configuration, such as inline, radial, “V”, and so on. Engine 12 may also include a geartrain 22 having a rotatable cam gear 24, to rotate a camshaft 26 having a plurality of cams 28 thereon. Engine 12 may be applied for electric power generation, vehicle propulsion such as in a land vehicle or a marine vessel, operation of a pump or a compressor, or in various other applications.

Engine 12 further includes a dual fuel system 30 having a first fuel supply 32 for a first fuel and a second fuel supply 34 for a second fuel. The first fuel may include a lower cetane number fuel, and in a practical implementation includes an alcohol fuel such as methanol, or a methanol blend. The second fuel may include a higher cetane number compression-ignition fuel, such as a liquid diesel distillate fuel, or a lower cetane number fuel blended with a cetane enhancer, for example. In the forthcoming discussion, the designation of fuel or components or features of engine system 10 as “first,” “second,” etc., is used for clarity in reference. It should be noted that these designations do not imply a fixed order or identity of the fuels or other components, and are used merely for descriptive convenience.

Dual fuel system 30 further includes a pump 36 structured to pump the second fuel by way of a fuel supply conduit 38 to engine 12, and another pump 40 structured to pump the first fuel by way of a fuel supply conduit 42 to engine 12. It should be appreciated that dual fuel system 30 may be equipped with multiple pumps for the first fuel and/or multiple pumps for the second fuel. Moreover, dual fuel system 30 could be equipped to utilize more than two types of fuel in some embodiments.

Dual fuel system 30 is designed to deliver, at times, a combined fuel charge of the first fuel and the second fuel, a single fuel charge of the second fuel, or potentially, a single fuel charge of the first fuel. It may also be desirable, at times, to vary a relative proportion of the second fuel in a fuel charge. To this end, dual fuel system 30 also includes a control system 44 including any suitable computerized electronic control unit structured to monitor and/or control various parameters of engine system 10, such as fuel pressure, injection timings, fueling amount and/or fuel proportions or “substitution ratio,” and so on. Control system 44 may also adjust a diesel or other second fuel metering amount based on various parameters, as discussed further herein. Control system 44 may be designed to send signals to various electronically controlled equipment in engine 12, such as fuel injectors 46, allowing a controllable amount of the second fuel to be admitted to each respective fuel injector 46 prior to injection, as also further discussed herein.

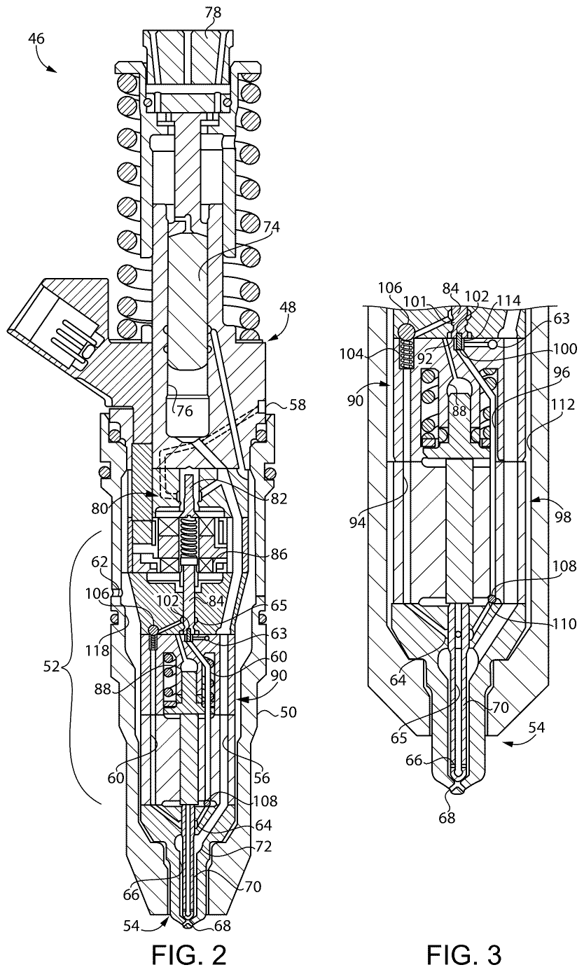

Dual fuel system 30 further includes a plurality of fuel injectors 46. Fuel injectors 46, hereinafter referred to, at times, in the singular, are generally interchangeable with one another in engine 12. Referring now also to FIG. 2, fuel injector 46 includes an injector housing 48 having an injector case 50 and a plurality of stack pieces 52 in a stack 98 in injector case 50. A variable number of stack pieces are contemplated herein. Fuel injector 46 also includes a nozzle 54 extending into a respective one of cylinders 16. Injector housing 48 forms a first nozzle supply passage 56 for the first fuel, fluidly connected to a first fuel inlet 58 fed by way of fuel supply conduit 42. Fuel injector 46 also includes a multi-channel nozzle supply path 60 for the second fuel, fluidly connected to a second fuel inlet 62 fed by way of fuel supply conduit 38.

It should be appreciated that the term “multi-channel nozzle supply path” denotes a designated route for the second fuel whereby two or more fuel passages convey the second fuel for injection, typically to a metering cavity 64. It should further be appreciated that each fuel passage of the multi-channel nozzle supply path can extend to metering cavity 64 in various configurations. Alternative strategies, placement, and number of the fuel passages of multi-channel nozzle supply path 60 are contemplated herein. In one example, multi-channel nozzle supply path extends in parallel in two passages to metering cavity 64. In other examples more than two fuel passages might be provided. From metering cavity 64, the second fuel may enter an internal passage of an outlet check 65 as further discussed herein, in a generally known manner. Outlet check 65 may be hydraulically actuated and electronically controlled to control a timing and a manner of fuel injection. Those skilled in the art will be familiar with operating a fuel injector to vary a closing hydraulic pressure on an outlet check to start and end fuel injection.

Injector housing 48 further forms a combined-fuel outlet passage 66 fluidly connected to both of first nozzle supply passage 56 and multi-channel nozzle supply path 60. Combined-fuel outlet passage 66 extends to a plurality of nozzle outlets 68 fluidly connecting to a corresponding cylinder 16. Fuel injector 46 further includes a nozzle check 70, movable based on a reduction to a closing hydraulic pressure in a check control chamber 88 to inject a combined fuel charge containing both the first fuel and the second fuel into a cylinder in engine 12, in a known manner. As elaborated in U.S. Pat. No. 11,384,721 B1, a dual fuel injector is described that provides delivery of a combined fuel charge of a leading fuel that is compression-ignited and a trailing fuel that is ignited by way of the compression-ignition of the leading fuel. Nozzle check 70 is movable in injector housing 48 between a closed position blocking nozzle outlets 74 from combined-fuel outlet passage 66, and an open position at which nozzle outlets 74 are fluidly connected to combined-fuel outlet passage 66. A fuel cavity 72 may extend circumferentially around nozzle check 70.

Fuel injector 46 also includes a plunger 74 movable in a plunger cavity 76 fluidly connected to first nozzle supply passage 56. A reciprocation of plunger 78 in plunger cavity 80 draws fuel into plunger cavity 80 and expels fuel from plunger cavity 80.

Advancing of plunger 74 can pressurize one or both of the first fuel and the second fuel in fuel injector 46 to an injection pressure. Fuel injector 46 may also include a tappet 78 coupled to plunger 74 and movable in response to rotation of a respective one of cams 28, in a generally conventional manner.

Fuel injector 46 further includes a valve assembly 80 having a spill valve 82 and a control valve 84. Operation of spill valve 82 may occur in a generally known manner. As can be seen in the illustrated embodiment of FIG. 1, spill valve 82 and control valve 84 are operated by way of an electrical actuator assembly 86 including, for example, a solenoid actuator assembly of a generally known design. Spill valve 82 is positioned fluidly between plunger cavity 76 and second fuel inlet 62 and is movable between a closed position blocking plunger cavity 76 from first fuel inlet 58, and an open position. Control valve 84 is designed to vary a pressure of the second fuel in a check control chamber 88. Opening control valve 84 at an appropriate timing in response to a reduction in pressure in control chamber 88 reduces a closing hydraulic pressure on nozzle check 70, permitting nozzle check 70 to open and inject a combined fuel charge containing both the first fuel and the second fuel, or a single-fuel charge containing only one of the first fuel or the second fuel, such as only the second fuel in a so-called diesel-only mode. Those skilled in the art will be familiar with opening and closing a control valve generally analogous to control valve 84 to hydraulically control nozzle check 70.

Fuel injector 46 further includes stack piece 90 forming a first valve seat 92. Control valve 84 is movable between a first position, in contact with first valve seat 92, blocking multi-channel nozzle supply path 60 from second fuel inlet 62, and an open position. In one example, multi-channel nozzle supply path 60 includes a first fuel passage 94 and a second fuel passage 96, both extending through a stack piece 98 to metering cavity 64. In this particular example, control valve 84 contacts both first valve seat 92 to block first fuel passage 94, and a second valve seat 100 to block second fuel passage 96 while in the first position. A fuel inlet passage 63 provides a feed of the second fuel from second fuel inlet 62 through stack piece 90 to a location that is fluidly between first valve seat 92 and second valve seat 100.

In a practical implementation, control valve 84 further includes a valve body 101 having a pin 102 attached thereon, such that valve body 101 and pin 102 coincidentally contact first valve seat 92 and second valve seat 100 when control valve 84 is at the first position. Fuel injector 46 may further include a first non-return valve 106 movable in fuel passage 94 between a first position and a closed position, permitting a flow of the second fuel through fuel passage 94 from second fuel inlet 62 towards nozzle 54. In a closed position, non-return valve 106 limits backflow of fuel through first fuel passage 94 toward second fuel inlet 62. Fuel passage 94 may fluidly connect to inlet passage 63, through valve seat 92, by way of passages not visible in the FIG. 3 illustration.

As also shown in FIGS. 2 and 3, first non-return valve 106 is positioned between control valve 84 and metering cavity 64, but variations in the number and/or positions of non-return valves are contemplated, contingent upon operational considerations, such as a number of fuel passages and/or specifications of fuel injector 46, or manufacturability more generally for instance. As also illustrated in FIGS. 2 and 3, second fuel passage 96 includes a second non-return valve 108 therein structured to contact another valve seat 110 formed in stack piece 90.

In a practical implementation non-return valve 106 can include a spring-biased design, and second non-return valve 110 can include a passively operated ball check. Either or both of non-return valves 106 and 108 might include a check plate in other embodiments, for example, or both could be spring-biased or passively operated in some instances. Each of valve seat 92 and valve seat 100 may include a flat valve seat in some embodiments. Metering cavity 64 can provide a feed of the second fuel supplied via multi-channel nozzle supply path 60. It can further be noted that a low-pressure space 112 is defined around stack 98, to permit a feed of the second fuel into inlet passage 63, and provide for venting pressure of control chamber 88 when control valve 84 is opened to start fuel injection.

Operational circumstances may sometimes motivate an increase to the proportion of the second fuel in an injection. In some instances, fuel injections may include substantially only the second fuel, such as in a so-called diesel-only mode for responding to an increased load demand, transients, or in other circumstances such as unavailability of excessive cost of the first fuel. Such an adjustment may require a correspondingly greater admitted volume of the second fuel in each engine cycle. Whereas certain earlier strategies provided only a single fuel passage to feed a second fuel to a fuel injector nozzle, the present disclosure provides a relatively increased available flow area utilizing the plurality of fuel passages of multi-channel nozzle supply path 60.

### Industrial Applicability

Referring to the drawings generally, it will be recalled that engine system 10 includes first fuel supply 32, second fuel supply 34, and the plurality of fuel injectors 46. In one example methodology, operating engine system 10 includes feeding the first fuel into first nozzle supply passage 56 in fuel injector 46, and feeding the second fuel into multi-channel nozzle supply path 60. Operating engine system 10 may also include opening control valve 84 at a first engine timing to admit the second fuel into multi-channel nozzle supply path 60, and then closing control valve 84. Opening control valve 84 at the first engine timing might include opening control valve 84 when the associated cam 28 is rotating on its base circle, for example, and plunger 74 is neither advancing nor retracting.

In one example, multi-channel nozzle supply path 60 includes first fuel passage 94 and second fuel passage 96 extending in parallel to metering cavity 64. From metering cavity 64, the admitted second fuel may flow into an internal passage 65 in nozzle check 70. The second fuel can then flow through nozzle check 70 into combined-fuel outlet passage 66. When operating in a dual fuel mode, the second fuel conveyed through internal passage 65 displaces some of the first fuel in combined-fuel outlet passage 66 to form a combined fuel charge including the second fuel leading and the first fuel trailing.

As also discussed herein, plunger 74 is advanced in fuel injector 46 to increase a pressure of the combined fuel charge to an injection pressure. Control valve 84 may be opened at a second engine timing to reduce a closing hydraulic pressure on nozzle check 70 in fuel injector 46, thereby opening nozzle check 70 to inject the combined fuel charge containing both the first fuel and the second fuel into cylinder 16 in engine 12. Opening control valve 84 to inject fuel may occur when the associated cam 28 is not rotating on its base circle, and instead is actuating plunger 74 to advance in fuel injector 46 with spill valve 82 closed.

Opening control valve 84 at the first timing can further include opening first valve seat 92 by way of valve body 101 of control valve 84, and opening second valve seat 100 by way of pin 102 attached to valve body 101. Backflow through first fuel passage 94 and second fuel passage 96 can be inhibited during the advancing of plunger 74 by way of first non-return valve 106 and second non-return valve 110, respectively.

In some instances, it may be desirable to increase the proportion of the second fuel, or inject solely the second fuel as in a so-called diesel-only mode as mentioned above. In such circumstances, operation can proceed similarly to the dual fuel mode operation discussed above, except that a relatively larger volume of the second fuel may be admitted via the operation of control valve 84, and the admitted volume of the second fuel can displace relatively more of the first fuel, sufficient to form a fuel charge for injection that is solely the second fuel. In such instances, control valve 84 may be held open longer than in the dual fuel mode, supply pressure of the second fuel might be increased, or some combination of these. It will be appreciated that a timing window for admission of a sufficient volume of the second fuel to operate engine 10 solely thereon can be relatively short. Accordingly, implementing multi-channel nozzle supply path 60 with more than one fuel passage to supply the fuel to be injected can provide advantages in the relatively short timing window for admission of the relatively greater volume of the second fuel.

It will also be recalled that fuel injector 46 includes control valve 84 having valve body 101, and a separate pin 102 that may be affixed to valve body 101. It will further be recalled that when control valve 84 is in a closed position, both valve body 84 and pin 102 contact respective valve seats 92,100. Further, as discussed above, when fuel injector 46 is placed in service, it can be desirable for the respective valve body 101 and pin 102 to contact seats 92,100 coincidentally. When preparing fuel injector 46 for service, a technician could consider the following approach.

Pin 102 may be inserted into a bore 114 formed in a tip of valve body 101, and then control valve 84 actuated a number of times. Initially, pin 102 may be positioned relatively less far into bore 114, such that upon actuating control valve 84 pin 102 will repeatedly be brought into contact with valve seat 100 while valve body 101 does not yet contact valve seat 100. Over a number of times of actuating control valve 84, pin 102 can be effectively hammered into bore 114. Thus, as control valve 84 is actuated, pin 102 advances deeper into bore 114 and a distance by which pin 102 extends beyond valve body 101 lessens. The actuation of control valve 84 can continue until pin 102 and control valve 84 each begin to contact a respective valve seat 92,100 coincidentally. At this point, repeated contacts of valve body 101 and pin 102 with the respective valve seats will not tend to cause further changes to the spacing between a tip of pin 102 and a tip of valve body 101, and control valve 84 is ready for service. Of course other strategies for obtaining coinciding seat contact could be employed, including potentially machining valve body 101 and/or pin 102 to sufficiently tight tolerances that the desired coincidental seat contact occurs. In some embodiments, rather than a separate valve body and pin, control valve 84 could be fashioned as a single, unitary piece.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more. ” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A dual fuel system comprising:
a first fuel supply for a first fuel;
a second fuel supply for a second fuel;
a fuel injector forming a first fuel inlet fluidly connecting a first nozzle supply passage to the first fuel supply, a second fuel inlet fluidly connecting a multi-channel nozzle supply path to the second fuel supply, and a combined-fuel outlet passage fluidly connected to both the first nozzle supply passage and to the multi-channel nozzle supply path and extending to a plurality of nozzle outlets;
the fuel injector further forming a valve seat, and including a control movable between a first position in contact with the valve seat and blocking the multi-channel nozzle supply path from the second fuel inlet, and an open position; and
the fuel injector further including a nozzle check movable from a closed position blocking the plurality of nozzle outlets from the combined-fuel outlet passage, to an open position to inject a combined fuel charge containing both the first fuel and the second fuel.

2. The dual fuel system of claim 1 wherein the multi-channel nozzle supply path includes a first fuel passage and a second fuel passage extending in parallel to a metering cavity for the second fuel.

3. The dual fuel system of claim 2 wherein the metering cavity circumferentially extends around the nozzle check.

4. The dual fuel system of claim 2 further including a first non-return valve in the first fuel passage and a second non-return valve in the second fuel passage.

5. The dual fuel system of claim 4 wherein the first non-return valve is spring-biased and the second non-return valve includes a passively operated ball check.

6. The dual fuel system of claim 2 wherein the control valve further includes a pin blocking both of the first fuel passage and the second fuel passage from the second fuel inlet when the control valve is at the first position.

7. The dual fuel system of claim 6 further including a second valve seat formed in the fuel injector, and wherein the pin contacts the second valve seat to block one of the first fuel passage or the second fuel passage when the control valve is at the first position.

8. A fuel injector comprising:
an injector housing forming a first nozzle supply passage for a first fuel, a multi-channel nozzle supply path for a second fuel, a combined-fuel outlet passage fluidly connected to both the first nozzle supply passage and the multi-channel nozzle supply path and extending to a plurality of nozzle outlets;
the injector housing further forming a valve seat, a check control chamber, and a fuel inlet for the second fuel;
a control valve movable between a first position and an open position, to vary a hydraulic pressure of the second fuel in the check control chamber, and to selectively fluidly connect the multi-channel nozzle supply passage to the second fuel inlet; and
a nozzle check movable from a closed position blocking the plurality of nozzle outlets from the combined-fuel outlet passage, to an open position, to inject a combined fuel charge containing both the first fuel and the second fuel.

9. The fuel injector of claim 8 wherein the control chamber is fluidly connected to at least one fuel passage of the multi-channel nozzle supply path when the control valve is at the open position.

10. The fuel injector of claim 9 further wherein the multi-channel fuel supply path includes a first fuel passage and a second fuel passage extending in parallel to a metering cavity for the second fuel formed in the injector housing.

11. The fuel injector of claim 10 further including a first non-return valve in the first fuel passage, and a second non-return valve in the second fuel passage.

12. The fuel injector of claim 10 wherein the injector housing further includes a plurality of stack pieces, and a first one of the plurality of stack pieces forms the valve seat contacted by the control valve at the first position, and each of the first fuel passage and the second fuel passage extends through both the first one of the plurality of stack pieces and a second one of the plurality of stack pieces.

13. The fuel injector of claim 12 wherein the injector housing further includes a second valve seat formed therein, and the control valve contacts both the first valve seat and the second valve seat at the first position.

14. The fuel injector of claim 13 wherein the second valve seat is formed in the first one of the plurality of stack pieces, and the control valve further includes an attached pin arranged to contact the second valve seat coincidentally with the contact of the first valve seat by the control valve.

15. The fuel injector of claim 14 wherein the second fuel inlet connects fluidly between the first valve seat and the second valve seat.

16. The fuel injector of claim 15 wherein each of the first valve seat and the second valve seat includes a flat valve seat.

17. A method of operating an engine system comprising:
feeding a first fuel into a first nozzle supply passage in a fuel injector;
feeding a second fuel into a multi-channel nozzle supply path in the fuel injector;
opening a control valve at a first timing to admit the second fuel into the multi-channel nozzle supply path;
closing the control valve;
opening the control valve at a second timing to reduce a closing hydraulic pressure on a nozzle check in the fuel injector;
opening the nozzle check based on the reduction to the closing hydraulic pressure to inject a fuel charge into a cylinder in an engine.

18. The method of claim 17 wherein the opening the nozzle check injects a combined fuel charge containing both the first fuel and the second fuel.

19. The method of claim 17 wherein the multi-channel nozzle supply path includes a first fuel passage and a second fuel passage extending in parallel to a metering cavity, and further comprising:
advancing a plunger in the fuel injector to increase a pressure of the combined fuel charge to an injection pressure; and
inhibiting backflow through the first fuel passage and the second fuel passage during the advancing a plunger by way of a first non-return valve and a second non-return valve, respectively.

20. The method of claim 17 wherein the opening the control valve at the first timing further includes opening a first valve seat by way of a valve body of the control valve and opening a second valve seat by way of a pin attached to the valve body.
